(19) United States
(12) Patent Application Publication
(10) Pub. No.: US 2009/0020422 A1
(43) Pub. Date: Jan. 22, 2009

(54) Sensor Assemblies For Analyzing NO and NO2 Concentrations In An Emission Gas And Methods For Fabricating The Same

(75) Inventors: Raju Raghurama A., Bangalore (IN); Joseph K. Boby, Bangalore (IN); Sanjeeb Tripathy, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/779,649

(22) Filed: Jul. 18, 2007

(51) Int. Cl. G01N 27/27; B05D 5/12; G01N 27/407

(52) U.S. Cl. 204/406; 204/424; 204/425; 427/77

(57) ABSTRACT

Sensor assemblies for analyzing NO and NO₂ concentrations in an emission gas and method for fabricating such sensor assemblies are provided. A sensor assembly comprises a first sensor having a first barium tungstate film. The first sensor is configured to detect a concentration of NOₓ in the gas and to provide a first signal associated with the concentration of NOₓ. NOₓ represents a combination of NO₂ and NO. The sensor assembly also comprises a second sensor disposed in a stationary position relative to the first sensor and having a second barium tungstate film. The second sensor is configured to detect a concentration of one of NO₂ and NO in the gas and to provide a second signal associated with the concentration of the one of NO₂ and NO.

### FIELD OF THE INVENTION

The present invention generally relates to nitrogen oxide sensors, and more particularly relates to nitrogen oxide sensor assemblies configured to analyze concentrations of nitrogen oxide and nitrogen dioxide in an emission gas.

### BACKGROUND OF THE INVENTION

Nitrogen oxides, in particular NO and NO₂ (hereinafter collectively “NOₓ”), are found in emissions from aircraft, automobiles and factories, and can cause damaging effects to human and animal bodies. NOₓ contributes to the production of acid rain, photochemical smog, and the depletion of the ozone layer. With an ever-increasing number of emission-producing vehicles, the amount of NOₓ produced also is increasing, causing deleterious effects on the global environment. Attempts to minimize environmental impacts have prompted efforts to reduce emissions from diesel and spark ignition engines. In particular, world-wide recommendations and laws for limiting NOₓ gas in emissions are becoming stricter for both industrial and domestic sources of pollution.

Such emissions standards have prompted attempts to develop on-board NOₓ sensors to monitor NO and NO₂ in emission gases. By measuring the concentrations of NO and NO₂ individually in an emission gas, methods can be used to neutralize the NO and NO₂ gases, converting them to harmless nitrogen and oxygen gases. However, to accurately and simultaneously analyze NO and NO₂ gas concentrations individually, such sensors should exhibit negligible sensing of concentrations of O₂, CO, CO₂, and SO₂.

Accordingly, it is desirable to provide sensor assemblies that can analyze and indicate the concentrations of NO gas and the concentrations of NO₂ gas in an emission gas with negligible sensing of concentrations of O₂, CO, CO₂, and SO₂. In addition, it is desirable to provide methods for fabricating such sensor assemblies. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In accordance with an exemplary embodiment of the present invention, sensor assembly for analyzing concentrations of NO₂ and NO in a gas is provided. The sensor assembly comprises a first sensor having a first barium tungstate film. The first sensor is configured to detect a concentration of NOₓ in the gas and to provide a first signal associated with the concentration of NOₓ. NOₓ represents a combination of NO₂ and NO. The sensor assembly also comprises a second sensor disposed in a stationary position relative to the first sensor and having a second barium tungstate film. The second sensor is configured to detect a concentration of one of NO₂ and NO in the gas and to provide a second signal associated with the concentration of the one of NO₂ and NO.

In accordance with another exemplary embodiment of the invention, a method for fabricating a sensor assembly for analyzing concentrations of NO₂ and NO in a gas is provided. The method comprises the step of fabricating a first sensor configured to detect a concentration of NOₓ in the gas and to provide a first signal associated with the concentration of NOₓ in the gas. NOₓ represents a combination of NO₂ and NO. The method also comprises the step of fabricating a second sensor configured to detect a concentration of one of NO₂ and NO in the gas and to provide a second signal associated with the concentration of the one of NO₂ and NO in the gas. The first and the second sensor are disposed so that they are in a stationary position relative to each other.

In accordance with a further exemplary embodiment of the invention, a sensor assembly for analyzing concentrations of NO₂ and NO in an emission gas is provided. The sensor assembly comprises a first sensor having a first barium tungstate film. The first sensor is configured to detect a concentration of NOₓ in the emission gas and to provide a first signal indicating the concentration of NOₓ. NOₓ represents a combination of NO₂ and NO. The sensor assembly further comprises a second sensor having a second barium tungstate film. The second sensor is configured to detect a concentration of NO₂ in the emission gas and to provide a second signal indicating the concentration of NO₂. A calculating means is configured to receive the first signal from the first sensor and the second signal from the second sensor and subtract the second signal from the first signal to produce a third signal that is associated with the concentration of NO in the emission gas.

### BRIEF DESCRIPTION OF THE DRAWINGS

The present invention will hereinafter be described in conjunction with the following drawing figures, wherein like numerals denote like elements, and wherein:

FIG. 1 is a cross-sectional view of a sensor assembly in accordance with an exemplary embodiment of the present invention;

FIG. 2 is a top view of a nitrogen oxide sensor of FIG. 1, in accordance with an exemplary embodiment of the present invention;

FIG. 3 is a bottom view of the nitrogen oxide sensor of FIG. 2, in accordance with an exemplary embodiment of the present invention;

FIG. 4 is a side view of the nitrogen oxide sensor of FIG. 2, in accordance with an exemplary embodiment of the present invention;

FIG. 5 is a cross-sectional view of a sensor assembly in accordance with an exemplary embodiment of the present invention; and

FIG. 6 is a flow chart of a method for fabricating the nitrogen oxide sensors of FIGS. 1 and 5, in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

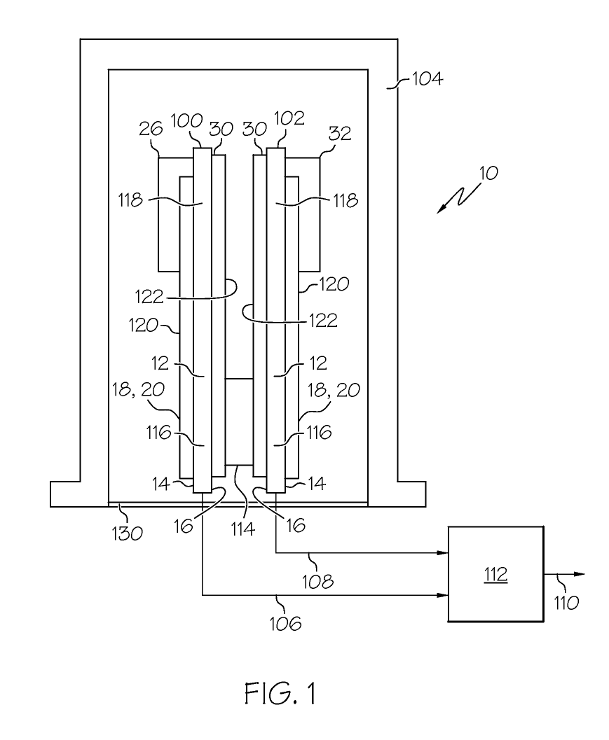

FIG. 1 is a cross-sectional view of a sensor assembly 10 in accordance with an exemplary embodiment of the present invention. As described in more detail below, sensor assembly 10 is configured to analyze and indicate concentrations of NO and concentrations of NO₂ present in an emission gas, such as an exhaust gas of an automobile or other vehicle. Sensor assembly 10 comprises a first sensor 100 that is configured, as described in more detail below, to measure the concentration of NOₓ in the emission gas and produce a signal, represented by arrow 106, associated with the concentration of NOₓ. As used herein, the term NOₓ refers to a combination of nitrogen oxide (NO) and nitrogen dioxide (NO₂). Sensor assembly 10 comprises a second sensor 102 that is configured, as described in more detail below, to detect the concentration of NO₂ in the gas and produce a signal, represented by arrow 108, associated with the concentration of NO₂. By subtracting the signal 108 associated with the concentration of NO₂ in the gas from the signal 106 associated with the concentration of NOₓ in the gas, a signal, represented by arrow 110, associated with the concentration of NO can be obtained. Accordingly, the sensor assembly 10 also may comprise a means 112 for subtracting signal 108 from signal 106 to obtain signal 110. The means 112 may comprise, for example, a differential amplifier and/or a microprocessor or the like.

The sensors are coupled in sensor assembly 10 so that they are positioned in a stationary manner relative to each other. In this regard, the sensors can be easily mounted so that they are in the flow of the emission gas. For example, sensor 100 and sensor 102 can be coupled so that back surfaces 122 of each sensor are facing each other with first ends 116 disposed proximate to each other, as illustrated in FIG. 1. The sensors are positioned in a stationary manner relative to each other by an insulating member 114 disposed between the sensors and affixed thereto. Insulating member 114 may comprise a low- or non-electrically and a low- or non-heat conducting material such as, a ceramic or a heat-resistant polymer. The insulating member 114 can be affixed to the sensors using, for example, a non-electrically and non-heat conducting epoxy. However, it will be appreciated that sensors 100 and 102 can be coupled in a stationary manner relative to each other in any of a number of other configurations that permit sensors 100 and 102 to be mounted so that they both are in the flow of an emission gas during production of the gas. For example, the sensors can be mounted on an insulating member so that top surfaces 120 of both sensors face in the same direction. In another embodiment, the sensors can be configured as illustrated in FIG. 1 but with the first end 116 of sensor 100 disposed proximate to a second end 118 of sensor 102.

In another embodiment, the sensors 100 and 102 may be fixedly coupled to a sensor envelop or cap 104, with or without the use of insulating member 114. The sensor envelope 104 may be formed of a porous material or a nonporous material, such as metal, with openings that permits nitrogen oxide species of the emission gas to flow through the material and past sensors 100 and 102 so that the concentration of the nitrogen oxide species can be measured. Preferably, the sensor envelope 104 is formed of a material that is capable of protecting sensors 100 and 102 from any physical contact and that is capable of withstanding heat from an emission gas of a high temperature, such as about 500° C. or higher. Examples of materials from which sensor envelope 104 may be formed include high nickel steels that can withstand substantial oxidation due to harsh engine environments. Sensor assembly 10 further may comprise a conductive sealing member 130 to encase sensors 100 and 102 within sensor assembly 10 and to facilitate the coupling of the sensors to cap 104. In one embodiment, sealing member 130 comprises a metal sheet, such as, for example, a nickel sheet.

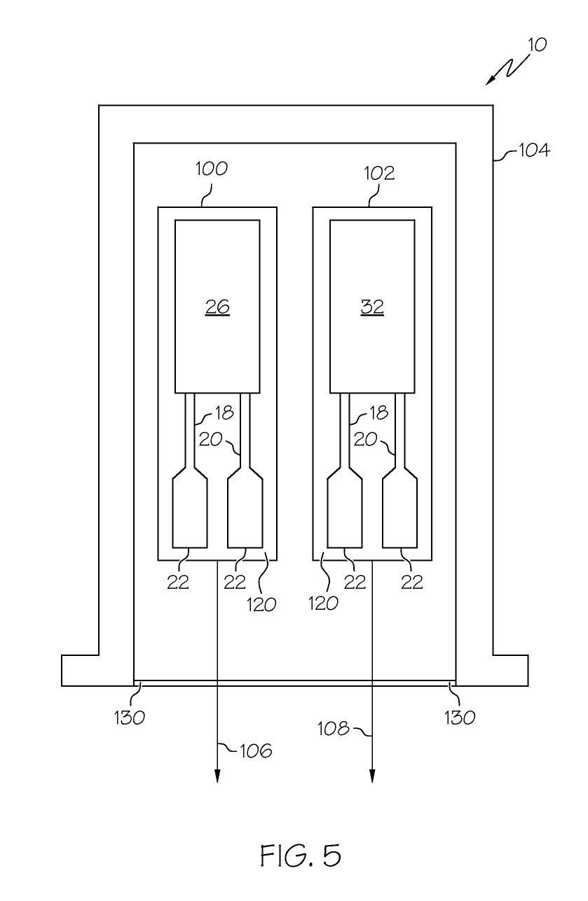

It will be understood that sensors 100 and 102 can be fixedly coupled to sensor envelope or cap 104, with or without the use of insulating member 114, in any number of other configurations that permit sensors 100 and 102 to be in the flow of an emission gas during production of the gas. For example, as illustrated in FIG. 5, sensors 100 and 102 may be coupled to sealing member 130, and hence cap 104, so that top surfaces 120 of sensors 100 and 102 are planar and face the same direction. This arrangement restricts the flow of the emission gas over the sensors and also protects the sensors from erosion that may result from the corrosive components of the emission gas and particulates in the emission gas.

Referring to FIGS. 1-5, in accordance with an exemplary embodiment of the present invention, sensors 100 and 102 each comprises a substrate 12 having a first surface 14 and a second surface 16. In an exemplary embodiment of the present invention, second surface 16 is parallel to first surface 14. The substrate may be formed from any suitable electrically-insulating and heat-resistant material such as, for example, a ceramic or polymer. In a preferred embodiment of the invention, the substrate is formed of alumina (Al₂O₃). The substrate 12 may have any suitable size and shape that permits sensor 100 or 102 to be positioned within a flow of an emission gas so that the nitrogen oxide concentrations of the gas can be measured. Preferably, the substrate 12 is an elongated plate having a thickness in the range of about 0.5 millimeters (mm) to about 1 mm, more preferably about 0.65 mm.

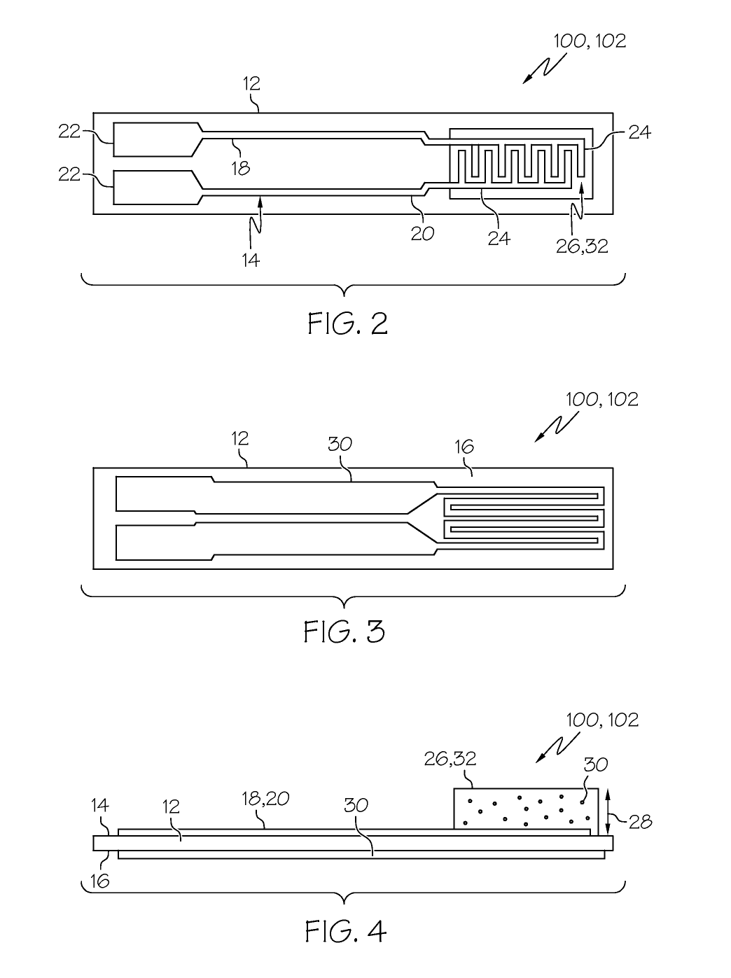

Each sensor 100 and 102 also includes a first electrode 18 and a second electrode 20 disposed on the first surface 14 of the substrate 12. The electrodes may be formed of any suitable electrically conductive material. Examples of suitable materials from which the electrodes 18 and 20 may be formed include, but are not limited to, platinum (Pt), gold (Au), nickel (Ni), silver (Ag), conducting polymers, conducting metal oxides, and the like. In a preferred embodiment of the invention, the electrodes 18 and 20 comprise platinum. Each electrode 18 and 20 has a first end 22 and a second end 24. The first end 22 of each electrode is configured to receive a current. The second ends 24 may be configured in any suitable manner for conducting a current therebetween. In an exemplary embodiment of the invention, the second ends 24 of electrodes 18 and 20 are formed in an inter-digital configuration, as illustrated in FIG. 2.

As described in more detail below, sensor 100 has a film 26 of barium tungstate (Ba_{X}W_{Y}O_{Z}) material (where 1≦x≦3, 1≦y≦3, and 1≦z≦9) disposed in electrical contact with the second ends 24 of the electrodes 18 and 20 of sensor 100 and sensor 102 has a film 32 of barium tungstate (Ba_{X}W_{Y}O_{Z}) material (where 1≦x≦3, 1≦y≦3, and 1≦z≦9) disposed in electrical contact with the second ends 24 of the electrodes 18 and 20 of sensor 102. In a preferred embodiment of the present invention, the films 26 and 32 are disposed overlying the electrodes 18 and 20 of sensors 100 and 102, respectively, although it will be appreciated that each of the films 26 and 32 may be formed underlying the electrodes, the second ends 24 of electrodes 18 and 20 may be sandwiched between two layers of the films 26 and 32, or the films 26 and 32 may be sandwiched between the two electrodes. The films 26 and 32 may be formed of any suitable barium tungstate material. In a preferred embodiment of the invention, the films are formed of BaWO₄, Ba₂WO₅, Ba₃W₂O₉, or a combination thereof. As illustrated in FIG. 4, the barium tungstate films 26 and 32 each has a thickness, indicated by double headed arrow 28. In an exemplary embodiment of the invention, the thickness 28 is in the range of about 0.1 micrometers (μm) to about 300 μm, preferably in the range of about 50 μm to about 200 μm.

Each of sensors 100, 102 further comprises a heater 30 disposed on second surface 16 of the substrate 12. The heater 30 is comprised of any suitable heat-conducting material that is capable of heating barium tungstate films 26 and 32 to a temperature of at least about 450° C., preferably to a temperature of at least 500° C. In an exemplary embodiment of the invention, the heater 30 is an elongated conductor formed of platinum.

In an exemplary embodiment of the invention, the sensor 100 has high sensitivity to NOₓ concentration in an emission gas when it is operated at a temperature of about 450° C. to about 550° C., preferably about 500° C. Referring to FIGS. 1-5, the barium tungstate film 26 of sensor 100 is a p-conducting material that is formulated, as described in more detail below, so that, when a constant electrical current is supplied through electrodes 18 and 20, the electrical resistance of the barium tungstate film 26 decreases as the concentration of NOₓ in the emission gas increases. The change in voltage necessary to maintain a constant current corresponds to the NOₓ concentration and, accordingly, is recorded as signal 106 that indicates the NOₓ concentration. While carbon monoxide (CO), carbon dioxide (CO₂), oxygen (O₂), hydrocarbons, nitric oxide (NO), and ammonia (NH₃) may be present in the gas, the barium tungstate film is negligibly sensitive to these gases. The CO converts to (CO₂) upon interaction with the barium tungstate film. CO₂ and O₂ are neutral gases and are not detected by the sensor 100. Similarly, hydrocarbons will decompose into water vapor, CO₂, and possibly hydrogen. The hydrogen will be converted into water vapor at this temperature and will not be detected by the sensor 100. Ammonia will decompose into nitrogen and hydrogen and the hydrogen thus formed also will be converted into water vapor. As these products are neutral in nature, the sensor may not detect them at a temperature within the relevant temperature range of about 450° C. to about 550° C.

In another exemplary embodiment of the invention, the sensor 102 has high sensitivity to NO₂ concentrations in an emission gas when it is operated at a temperature of about 450° C. to about 550° C., preferably about 500° C. The barium tungstate film 32 of sensor 102 is a p-conducting material that is formulated, as described in more detail below, so that, when a constant electrical current is supplied through electrodes 18 and 20, the electrical resistance of the barium tungstate film 32 decreases as the concentration of NO₂ in the gas increases. The change in voltage necessary to maintain a constant current corresponds to the NO₂ concentration and, accordingly, is represented as signal 108 that indicates the NO₂ concentration. As with sensor 100, while carbon monoxide (CO), carbon dioxide (CO₂), oxygen (O₂), hydrocarbons, nitric oxide (NO), and ammonia (NH₃) may be present in the gas, the barium tungstate film 32 of sensor 102 is negligibly sensitive to these gases, when operated within the relevant temperature range of about 450° C. to about 550° C.

In an exemplary embodiment of the present invention, the barium tungstate films 26 and 32 may be doped with a suitable dopant or dopants 30 to enhance the sensitivity and selectivity of the film 26 to particular gases. For example, noble metal particles such as platinum (Pt), palladium (Pd), ruthenium (Ru), and/or rhodium (Rh) particles can be impregnated in the barium tungstate films 26 and 32, and/or can be dispersed on the surface of the film.

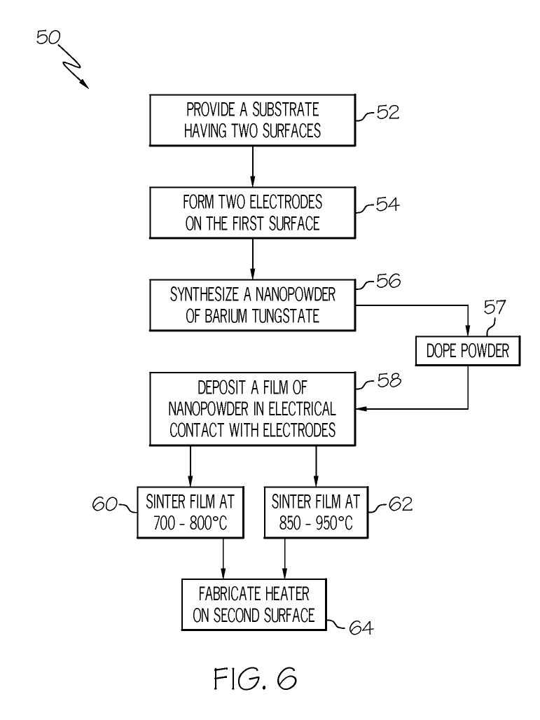

FIG. 6 illustrates a method 50 for fabricating each of sensors 100 and 102 in accordance with an exemplary embodiment of the present invention. Various steps in the manufacture of sensors 100 and 102 are well known and so, in the interest of brevity, many conventional steps will only be mentioned briefly herein or will be omitted entirely without providing well known process details.

In an exemplary embodiment of the invention, to form sensor 100 or 102 method 50 begins by providing an electrically-insulating and heat-resistant substrate plate having a first surface and a second surface (step 52). As described above, the substrate can be formed from any suitable electrically-insulating and heat-resistant substrate such as, for example, alumina. Two electrodes of an electrically conductive material are formed on the first surface of the substrate (step 54). The electrodes may be formed of any suitable electrically conductive material such as, for example, platinum (Pt), gold (Au), nickel (Ni), silver (Ag), conducting metal oxides, and the like, by any suitable method. In an exemplary embodiment of the invention, the electrodes are formed by combining a platinum paste, ink, or paint, either pure or with a suitable glass matrix or similar binding material having a melting point of about 750° C. to 800° C., and screen printing the platinum paste/glass matrix mixture in a desired configuration onto the substrate. The electrodes are then sintered. For example, the electrodes can be sintered at about 1000° C. As the described above, the electrodes can have any suitable form or structure conducive to conducting a current therebetween. In an exemplary embodiment of the invention, the electrodes are formed having an elongated structure with inter-digital ends, as illustrated in FIG. 2.

Referring again to FIG. 6, a barium tungstate nanopowder is synthesized (step 56). Preferably, the nanopowder that is synthesized comprises BaWO₄, Ba₂WO₅, Ba₃W₂O₉, or any combination thereof. The sensitivity to NOₓ or NO₂ of the barium tungstate film subsequently formed on the substrate, as discussed in more detail below, is determined in part by the particle size and porosity of the barium tungstate film. In turn, the particle size and porosity of the barium tungstate film are determined in part by the size of the nanoparticles that make up the barium tungstate nanopowder. In one embodiment of the invention, the nanopowder is formed from nanoparticles having an average size in the range of about 3 to about 40 nm.

The barium tungstate nanopowder may be synthesized using any suitable method that results in a nanopowder having nanoparticles in the range of about 10 to about 200 nm in size. In one exemplary embodiment of the invention, the barium tungstate nanopowder is synthesized using a chemical vapor synthesis method. In accordance with this method, appropriate portions of acetylacetonates of barium and tungsten are incorporated into an organic solution, such as, for example, a methanol solution to form a starting solution. For example, to prepare a BaWO₄ nanopowder, the starting solution may be formed from one mole of barium acetylacetonate and one mole of tungsten acetylacetonate. To prepare a Ba₂WO₅ nanopowder, the starting solution will be formed from two moles of barium acetylacetonate and one mole of tungsten acetylacetonate and to prepare a Ba₃W₂O₉ nanopowder, the starting solution will be formed from three moles of barium acetylacetonate and two moles of tungsten acetylacetonate. The starting solution is evaporated into a vapor and the vapor is passed into a chemical vapor synthesis chamber having halogen lamps therein and having cooled chamber walls. A gas, such as air and helium, is pumped into the chamber at a predetermined flow rate. The vapor decomposes upon entering the chamber and reacts with oxygen in the gas to form a barium tungstate nanocrystalline powder. The nanocrystalline powder is attracted to the cold chamber walls by a thermo-gravitational process and the particle size is seized due to this process. The size of the particles depends on the temperature of the chamber, which is maintained at a temperature in the range of about 150° C. to about 200° C., and the flow rate of the gas. The resulting nanoparticles of the nanopowder have a substantially spherical shape and are substantially uniform in size. In a preferred embodiment of the invention, the nanoparticles formed by the chemical vapor synthesis method have an average size in the range of about 3 to about 10 nm.

In another exemplary embodiment of the invention, the barium tungstate nanopowder may be synthesized by a solid-state reaction. In this process, equimolar concentrations of barium acetate and tungsturic acid are combined. In accordance with one exemplary embodiment of the present invention, suitable molar ratios of barium nitrate and tungsturic acid are ball milled in a wet medium of, for example, isopropyl alcohol, and the resultant mixture is heated to about 400° C. for about 2 hours. The mixture then is reground and heated to about 600° C. for about 2 hours. The resultant powder is ground and heated to about 650° C. for about one hour and then cooled. The powder then is reground and reheated to 800° C. for one hour and is cooled to obtain a phase pure compound of suitable composition. The resulting nanoparticles of the nanopowder have nearly uniform particle size. In a preferred embodiment of the invention, the nanoparticles formed by the above-described solid-state method have an average size in the range of about 100 to about 200 nm.

In accordance with an exemplary embodiment of the invention, the barium tungstate powder optionally may be doped with a suitable dopant or dopants to enhance the sensitivity and selectivity of the powder to the particular gases (step 57). For example, the barium tungstate powder can be doped with noble metal particles such as platinum (Pt), palladium (Pd) and/or rhodium(Rh) particles to enhance the resulting barium tungstate film's sensitivity to NOₓ or NO₂ for sensor 100 or sensor 102, respectively, and reduce sensitivity to CO, CO₂, hydrocarbon, and O₂ gases. The dopants can be impregnated in the barium tungstate powder by adding the particles to the mediums described above or otherwise can be dispersed on the surface of the powder. In one exemplary embodiment, approximately 1 to 5% dopant may be added to the barium tungstate powder. For example, once formed, the barium tungstate nanopowder can be impregnated with about 2 to about 10 molar percent of platinum chloride by a wet impregnation method, which is a well known method. The impregnated powder is heated to a temperature in the range of about 500 to about 700° C., preferably about 600° C., for about one hour and furnace cooled.

The powder then is used to make a screen-printable ink. In one exemplary embodiment, the powder is combined with a commercial solvent or thinner, such as, for example, ESL 400 vehicle available from Electro-Sciences Laboratories of King of Prussia, Pa., and is made into screen printable ink by ball milling. The powder-to-vehicle ratio is in the range of about 95:5 to about 70:30. In another exemplary embodiment, the impregnated powder may be mixed thoroughly with about 1 to about 5 molar percent of an inorganic binder, such as antimony oxide. The resulting nanopowder mixture is deposited as a film, such as film 26 or 32, on the first surface of the substrate by screen printing, spin coating, or dip coating (step 58). It will be appreciated that any other suitable method for depositing the barium tungstate film on the substrate also may be used. In one exemplary embodiment of the present invention, the barium tungstate film is deposited overlying the second ends of the electrodes. In another exemplary embodiment, the barium tungstate film is deposited on the substrate before the electrodes are formed on the substrate (that is, before step 54). In a further exemplary embodiment, a barium tungstate film is deposited before the electrodes are formed on the substrate and is deposited overlying the second ends of the electrodes such that the electrodes are effectively “sandwiched” between two barium tungstate films. Alternatively, one of the electrodes can be formed on the substrate, followed by the deposition of the barium tungstate film and the subsequent formation of the second electrode. While the nanopowder mixture may be deposited to any suitable thickness, preferably the mixture is deposited so that, upon sintering, described below, the barium tungstate film has a thickness in the range of about 20 micrometers (μm) to about 200 μm, preferably in the range of about 50 μm to about 100 μm.

The method in accordance with an exemplary embodiment of the present invention continues with the sintering of the nanopowder film. The temperature at which the nanopowder film is sintered determines the sensitivity of the film to NO₂ alone or to NOₓ when an electric current is supplied therethrough. In this regard, the nanopowder film of sensor 100 is sintered so that sensor 100 is about equally sensitive to the concentrations of NO and NO₂. In an exemplary embodiment of the present invention, the barium tungstate film 26 of sensor 100 is sintered at a temperature range of about 700 to about 800° C., preferably at a temperature of about 700° C. (step 60). In another exemplary embodiment of the invention, the barium tungstate film 26 is sintered for about 5 minutes to about 1 hour, preferably for about 30 minutes. In a further exemplary embodiment of the invention, the sintering is performed with a heater resistance of about 15-18 ohms, preferably about 16 ohms. By regulating the sintering temperature and time to these ranges, the grain size and the porosity of the barium tungstate film 26 can be controlled. If the grain growth is too large, the porosity of the film is reduced and, hence the sensitivity of the film to NOₓ, that is, with equal sensitivity to NO and NO₂, is decreased. In addition to regulating the particle size and the porosity of the barium tungstate film, sintering at such high temperatures causes the sensors to be operable at such high temperatures, preferably at temperatures of about 500° C. and higher.

The nanopowder film of sensor 102 is sintered so that sensor 102 is sensitive to the NO₂ concentration of the emission gas. In one exemplary embodiment of the present invention, the barium tungstate film 32 of sensor 102 is sintered at a temperature range of about 800 to about 950° C., preferably at a temperature of about 900° C. (step 62). In another exemplary embodiment of the invention, the barium tungstate film 32 is sintered for about 1 to 5 hours, preferably for about 3 hours. In a further exemplary embodiment of the invention, the sintering is performed with a heater resistance of about 15-18 ohms, preferably about 16 ohms. By regulating the sintering temperature and time to these ranges, the grain size and the porosity of the barium tungstate film can be controlled. Again, if the grain growth is too large, the porosity of the film is reduced and, hence the sensitivity of the film to NO₂ is decreased. In another exemplary embodiment of the invention, the nanopowder film of sensor 102 is sintered so that sensor 102 is sensitive to the NO concentration of the emission gas. In this regard, signal 108 produced by sensor 102 can be subtracted from signal 106 produced by sensor 100 to obtain a signal 110 that indicates the concentration of NO₂ in the emission gas.

Method 50 further comprises the step of forming a heater on the second surface of the substrate of each sensor 100, 102 (step 64). The heater may be formed of the same material as the electrodes formed on the first surface of the substrate or may be formed of any other suitable electrically-conductive material such as, for example, platinum (Pt), gold (Au), silver (Ag), nickel (Ni), conducting polymers, conducting metal oxides, and the like, by any suitable method. In an exemplary embodiment of the invention, the heater is formed by combining a platinum paste with a suitable glass matrix and screen printing the platinum paste/glass matrix mixture in a desired form onto the substrate. The heater then is sintered, for example at about 1000° C. The heater can have any suitable form or structure conducive to heating the barium tungstate film to a temperature no less than about 450° C., preferably no less than about 500° C. It will be appreciated that, while step 64 of forming a heater on the substrate is indicated as the last step of method 50, the step 64 of forming a heater may be performed as the first step of the method 50, as any step between step 52 and steps 60 or 62, or during any of the illustrated steps. For example, in one exemplary embodiment of the invention, the step of forming the heater on the second surface of the substrate may be performed substantially during the step of forming two electrodes on the first surface of the substrate (step 54).

Accordingly, sensor assemblies for analyzing NO and NO₂ concentrations in an emission gas and methods for forming such sensors have been provided. The sensor assemblies comprise a first sensor that is configured to provide a first signal associated with a concentration of NOₓ in the gas, wherein NOₓ represents a combination of NO₂ and NO, and a second sensor that is configured to provide a second signal associated with the concentration of NO₂ in the gas. By subtracting the second signal from the first signal, a concentration of NO can be determined. Once the concentrations of NO and NO₂ in the gas are known, methods can be performed to neutralize the NO and NO₂ in the gas. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A sensor assembly for analyzing concentrations of NO₂ and NO in a gas, the sensor assembly comprising:
a first sensor having a first barium tungstate film, wherein the first sensor is configured to detect a concentration of NOₓ in the gas and to provide a first signal associated with the concentration of NOₓ, wherein NOₓ represents a combination of NO₂ and NO; and
a second sensor disposed in a stationary position relative to the first sensor and having a second barium tungstate film, wherein the second sensor is configured to detect a concentration of one of NO₂ and NO in the gas and to provide a second signal associated with the concentration of the one of NO₂ and NO.

2. The sensor assembly of claim 1, further comprising a means for calculating the concentration of the other of NO₂ and NO in the gas from the first signal and the second signal.

3. The sensor assembly of claim 2, wherein the means for calculating the concentration of the other of NO₂ and NO in the gas comprises a differential amplifier.

4. The sensor assembly of claim 2, wherein the means for calculating the concentration of the other of NO₂ and NO in the gas comprises a microprocessor.

5. The sensor assembly of claim 1, wherein the first sensor and the second sensor each comprises:
an electrically-insulating substrate having a first surface and a second surface;
two electrodes on the first surface of the electrically-insulating substrate, wherein each of the two electrodes has a first end configured to receive a current and a second end; and
a heater disposed on the second surface of the electrically-insulating substrate.

6. The sensor assembly of claim 5, wherein the first barium tungstate film is disposed on the second ends of the two electrodes of the first sensor and the second barium tungstate film is disposed on the second ends of the two electrodes of the second sensor.

7. The sensor assembly of claim 5, wherein the first barium tungstate film, having been sintered at a temperature in the range of about 700 to about 800° C., has a grain size and porosity such that it is about equally sensitive to the concentrations of NO and NO₂ when a constant electrical current is supplied to the two electrodes of the first sensor and the heater of the first sensor is heated to a temperature of about 450 to 550° C.

8. The sensor assembly of claim 7, wherein the first barium tungstate film, having been sintered for about 5 minutes to about one hour, has a grain size and porosity such that it is about equally sensitive to the concentrations of NO and NO₂ when a constant electrical current is supplied to the two electrodes of the first sensor and the heater of the first sensor is heated to a temperature of about 450 to 550° C.

9. The sensor assembly of claim 5, wherein the second barium tungstate film, having been sintered at a temperature in the range of about 800 to about 950° C., has a grain size and porosity such that it is sensitive to the concentrations of one of NO and NO₂ when a constant electrical current is supplied to the two electrodes of the second sensor and the heater of the second sensor is heated to a temperature of about 450 to 550° C.

10. The sensor assembly of claim 9, wherein the second barium tungstate film, having been sintered for about one to about five hours, has a grain size and porosity such that it is sensitive to the concentrations of one of NO and NO₂ when a constant electrical current is supplied to the two electrodes of the second sensor and the heater of the second sensor is heated to a temperature of about 450 to 550° C.

11. The sensor assembly of claim 1, wherein the first sensor and the second sensor are fixedly coupled to a porous cap.

12. The sensor assembly of claim 1, wherein the first barium tungstate film and the second barium tungstate film each comprises BaWO₄, Ba₂WO₅, Ba₃W₂O₉, or any combination thereof.

13. A method for fabricating a sensor assembly for analyzing concentrations of NO₂ and NO in a gas, the method comprising the steps of:
fabricating a first sensor configured to detect a concentration of NOₓ in the gas and to provide a first signal associated with the concentration of NOₓ in the gas, wherein NOₓ represents a combination of NO₂ and NO;
fabricating a second sensor configured to detect a concentration of one of NO₂ and NO in the gas and to provide a second signal associated with the concentration of the one of NO₂ and NO in the gas; and
disposing the first and the second sensor so that they are in a stationary position relative to each other.

14. The method of claim 13, further comprising the step of electrically coupling the first sensor and the second sensor to a means for subtracting the second signal from the first signal to produce a third signal that is associated with a concentration of the other of NO₂ and NO in the gas.

15. The method of claim 14, wherein the step of electrically coupling the first sensor and the second sensor to the means for subtracting the second signal from the first signal to produce the third signal that is associated with a concentration of the other of NO₂ and NO in the gas comprises the step of electrically coupling the first sensor and the second sensor to differential amplifier.

16. The method of claim 13, wherein the step of fabricating the first sensor comprises the steps of:
providing a first electrically-insulating substrate having a first surface and a second surface;
fabricating two inter-digital electrodes on the first surface of the first electrically-insulating substrate, wherein each of the two electrodes has a first end configured to receive a current and a second end;
fabricating a heater on the second surface of the first electrically-insulating substrate;
synthesizing a first nanopowder of a barium tungstate, wherein the barium tungstate may comprise BaWO₄, Ba₂WO₅, Ba₃W₂O₉, or any combination thereof;
depositing a first film of the first nanopowder overlying the first surface of the first electrically-insulating substrate; and
sintering the first film at a temperature in the range of about 700 to about 800° C.,
wherein, after the two electrodes and the first film are formed, the first film is in electrical contact with the second ends of the two electrodes on the first electrically-insulating substrate.

17. The method of claim 16, wherein the step of sintering comprises the step of sintering the first film for about 0.5 minutes to about one hour.

18. The method of claim 16, wherein the step of fabricating the second sensor comprises the steps of:
providing a second electrically-insulating substrate having a first surface and a second surface;
fabricating two inter-digital electrodes on the first surface of the second electrically-insulating substrate, wherein each of the two electrodes has a first end configured to receive a current and a second end;
fabricating a heater on the second surface of the second electrically-insulating substrate;
synthesizing a second nanopowder of a barium tungstate, wherein the barium tungstate may comprise BaWO₄, Ba₂WO₅, Ba₃W₂O₉, or any combination thereof; depositing a second film of the second nanopowder overlying the first surface of the second electrically-insulating substrate; and
sintering the second film at a temperature in the range of about 800 to about 950° C.,
wherein, after the two electrodes and the second film are formed, the second film is in electrical contact with the second ends of the two electrodes on the second electrically-insulating substrate.

19. The method of claim 18, wherein the step of sintering the second film comprises the step of sintering the second film for about one to about five hours.

20. A sensor assembly for analyzing concentrations of NO₂ and NO in an emission gas, the sensor assembly comprising:
a first sensor having a first barium tungstate film, wherein the first sensor is configured to detect a concentration of NOₓ in the emission gas and to provide a first signal indicating the concentration of NOₓ, wherein NOₓ represents a combination of NO₂ and NO; and
a second sensor having a second barium tungstate film, wherein the second sensor is configured to detect a concentration of NO₂ in the emission gas and to provide a second signal indicating the concentration of NO₂; and
a calculating means configured to receive the first signal from the first sensor and the second signal from the second sensor and subtract the second signal from the first signal to produce a third signal that is associated with the concentration of NO in the emission gas.
